(19) United States
(12) Patent Application Publication
(10) Pub. No.: US 2012/0293072 A1
(43) Pub. Date: Nov. 22, 2012

(54) FREQUENCY-VARIABLE DIMMING CONTROL APPARATUS FOR LIGHT-EMITTING DIODES AND METHOD FOR OPERATING THE SAME

(76) Inventors: Shih-Hsien CHANG, Taoyuan Shien (TW); Po-Nien Ko, Taoyuan Shien (TW)

(21) Appl. No.: 13/243,682

(22) Filed: Sep. 23, 2011

(30) Foreign Application Priority Data
May 18, 2011 (TW) 100117325

(51) Int. Cl. H05B 37/02

(52) U.S. Cl. 315/121

(57) ABSTRACT

A frequency-variable dimming control apparatus for a plurality of light-emitting diodes (LEDs) and a method for operating the same are disclosed. The frequency-variable dimming control apparatus is provided for dimming the LEDs. The frequency-variable dimming control apparatus includes a DC/AC converter, a resonance circuit, a transformer, a current-sensing unit, and a control unit. The DC/AC converter receives and converts a DC input voltage into an AC voltage. The resonance circuit is electrically connected to the DC/AC converter to receive and converter the AC voltage into a resonance voltage. The transformer receives the resonance voltage and outputs an AC driven voltage. The current-sensing unit is electrically connected to a secondary-side winding of the transformer to output a current frequency signal. The control unit is electrically connected to the current-sensing unit and the DC/AC converter to receive a dimming control signal for dimming the LEDs.

### BACKGROUND OF THE INVENTION

1. Field of the Invention

The present invention relates generally to a dimming control apparatus and a method for operating the same, and more particularly to a frequency-variable dimming control apparatus for light-emitting diodes and a method for operating the same.

2. Description of Prior Art

For many years, the light-emitting diodes (LEDs) play an important role in the backlight of portable electronic products. In the lighting application, LEDs are the most crucial components in the solid-state lighting industry. The advantages of LEDs include: energy saving, long life-span, free of maintenance, long life-span, and so on. In addition, a well-matched driving circuit for driving LEDs is very necessary in whether the lighting, the backlight, or the display fields. Especially to deserve to be mentioned, the backlight module is an important apparatus for the flat panel display. The backlight module determines the display quality of the flat panel display because of the reliability and stability of the LEDs.

Reference is made to FIG. 1 which is a schematic view of a prior art dimming control circuit for a light-emitting diode (LED) string. The LED string 30A is electrically connected in series to a switch component 20A. In particular, the switch component 20A can be a transistor. A pulse width modulation (PWM) signal (not shown) is outputted from a control circuit 10A to control the switch component 20A, thus controlling a duty cycle of a current flowing through the LED string 30A. Because the brightness of each light-emitting diode of the LED string 30A is proportional to the forward current, the LED string 30A produces larger brightness when the duty cycle of the forward current increases, and vice versa.

Because a flat panel display needs a number of LED strings as the backlight source, the LED strings are controlled by the corresponding LED driving circuit. A pulse-width modulation (PWM) technology is commonly used to adjust current magnitude flowing through the LED string by controlling switches. In addition, each LED string needs to mate with a transistor switch, therefore, a considerable amount of transistor switches are used, thus increasing costs of the components and reducing reliability thereof.

Accordingly, it is desirable to provide a frequency-variable dimming control apparatus for light-emitting diodes and a method for operating the same. According to on/off states of a dimming control signal, a control unit provides frequency-variable control voltage signals to execute a dimming operation for the light-emitting diodes.

### SUMMARY OF THE INVENTION

An object of the invention is to provide a frequency-variable dimming control apparatus to solve the above-mentioned problems.

The frequency-variable dimming control apparatus is applied to provide a dimming operation for a plurality of light-emitting diodes, and the frequency-variable dimming control apparatus includes a DC/AC converter, a resonance circuit, a transformer, and a control unit.

The DC/AC converter has a plurality of power switches, and the DC/AC converter receives a DC input voltage and converts the DC input voltage into an AC voltage. The resonance circuit is electrically connected to the DC/AC converter, and the resonance circuit receives the AC voltage and converts the AC voltage into a resonance voltage. The transformer has a primary-side winding and the primary-side winding is electrically connected to the resonance circuit to receive the resonance voltage. The control unit is electrically connected to the DC/AC converter, and the control unit receives an external dimming control signal.

Wherein the control unit provides a plurality of control voltage signals; wherein frequencies of the control voltage signals to be equal to a resonance frequency of the resonance voltage when the dimming control signal is turned on; wherein frequencies of the control voltage signals to be larger than the resonance frequency of the resonance voltage when the dimming control signal is turned off.

Another object of the invention is to provide a method for operating a frequency-variable dimming control apparatus to solve the above-mentioned problems. The method of operating the frequency-variable dimming control apparatus for a plurality of light-emitting diodes includes the following steps: First, a DC/AC converter and a resonance circuit are provided for receiving a DC input voltage and converting the DC input voltage into a resonance voltage. Afterward, a transformer is provided for receiving the resonance voltage. Finally, a control unit is provided for receiving an external dimming control signal.

Wherein, the control unit provides a plurality of control voltage signals to render frequencies of the control voltage signals to be equal to a resonance frequency of the resonance voltage when the dimming control signal is turned on; the control unit to render frequencies of the control voltage signals to be larger than the resonance frequency of the resonance voltage when the dimming control signal is turned off.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic view of a prior art dimming control circuit for a light-emitting diode string;

FIG. 2 is a circuit diagram of a frequency-variable dimming control apparatus for light-emitting diodes according to a first embodiment of the present invention;

FIG. 3 is a circuit diagram of the frequency-variable dimming control apparatus for light-emitting diodes according to a second embodiment of the present invention;

FIG. 4 is a circuit diagram of the frequency-variable dimming control apparatus for light-emitting diodes according to a third embodiment of the present invention;

FIG. 5 is a circuit diagram of the frequency-variable dimming control apparatus for light-emitting diodes according to a fourth embodiment of the present invention;

FIG. 6 is a schematic voltage and current waveform graph of the frequency-variable dimming control apparatus for light-emitting diodes; and

FIG. 7 is a DC characteristic curve graph of a resonance circuit of the frequency-variable dimming control apparatus for light-emitting diodes; and

FIG. 8 is a flowchart of a method for operating the frequency-variable dimming control apparatus for light-emitting diodes of the present invention.

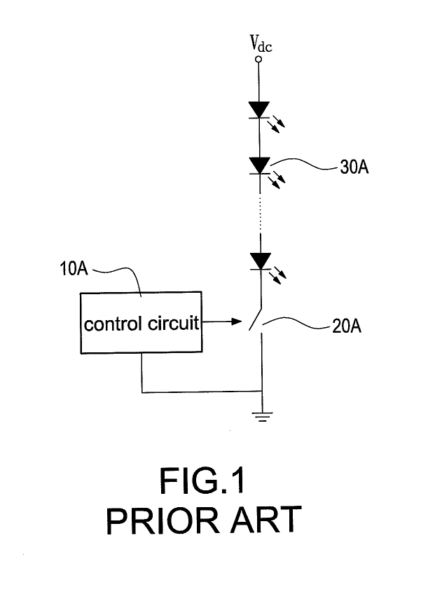

### DETAILED DESCRIPTION OF THE INVENTION

Reference will now be made to the drawing figures to describe the present invention in detail.

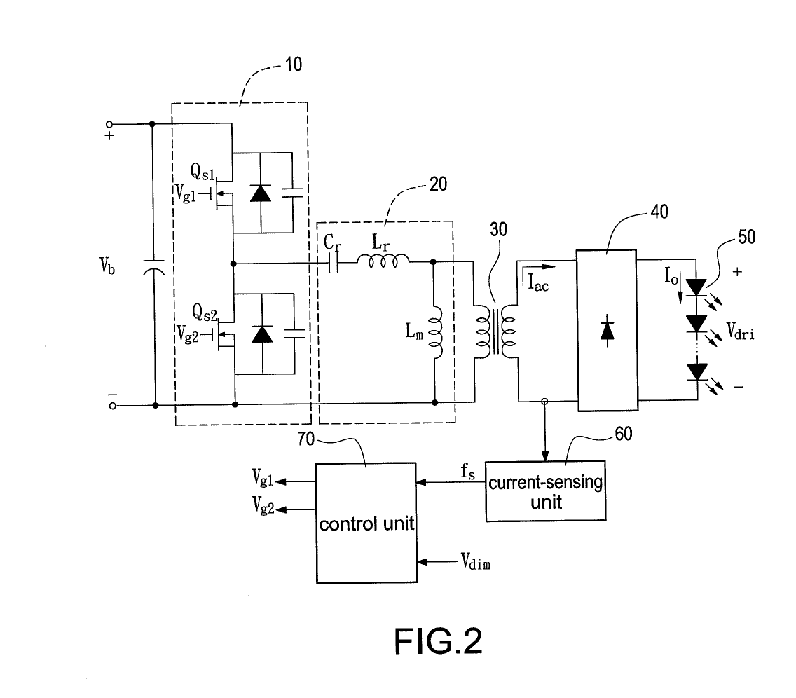

Reference is made to FIG. 2 which is a circuit diagram of a frequency-variable dimming control apparatus for light-emitting diodes according to a first embodiment of the present invention. The frequency-variable dimming control apparatus is applied to provide a dimming operation for a plurality of light-emitting diodes 50. The frequency-variable dimming control apparatus includes a DC/AC converter 10, a resonance circuit 20, a transformer 30, a rectifying circuit 40, a current-sensing unit 60, and a control unit 70.

In the present invention, the DC/AC converter 10 can be a half-bridge DC/AC converter, a full-bridge DC/AC converter, or a class-E converter, but not limited. The half-bridge DC/AC converter is exemplified for further demonstration in this embodiment, and the full-bridge DC/AC converter will be exemplified in another embodiment. However, the class-E converter provides the same purpose to the half-bridge DC/AC converter or the full-bridge DC/AC converter, hence, the detail description is omitted here for conciseness.

In this embodiment, the DC/AC converter 10 has two power switches, namely, a first power switch Qs1 and a second power switch Qs2, for receiving a DC input voltage Vb and converting the DC input voltage Vb into an AC voltage (not labeled). The resonance circuit 20 is electrically connected to the DC/AC converter 10 for receiving the AC voltage and converting the AC voltage into a resonance voltage (not labeled). In particular, the resonance circuit 20 includes a resonance capacitance Cr and two resonance inductances (including a leakage inductance Lr and a magnetizing inductance Lm of the transformer 30), which form a LLC resonance circuit. The transformer 30 has a primary-side winding (not labeled) and a secondary-side winding (not labeled). The primary-side winding is electrically connected to the resonance circuit 20 for receiving the resonance voltage and outputting an AC driven voltage (not labeled). In particular, the resonance inductances of the resonance circuit 20 are the primary-side leakage inductance Lr and the magnetizing inductance Lm of the transformer 30. The current-sensing unit 60 is electrically connected to the secondary-side winding of the transformer 30 for sensing a secondary-side current Iac of the transformer 30 and outputting a current frequency signal fs. Instead of sensing the secondary-side current Iac of the transformer 30, a primary-side current of the transformer 30 can be also sensed by the current-sensing unit 60. The control unit 70 is electrically connected between the current-sensing unit 60 and the DC/AC converter 10.

The control unit 70 receives an external dimming control signal Vdim. In particular, the external dimming control signal Vdim is provided through a microcontroller (not shown) or a pulse width modulation signal generator (not shown). The control unit 70 provides two control voltage signals, namely, a first control voltage signal Vg1 and a second control voltage signal Vg2, and frequencies of the first control voltage signal Vg1 and the second control voltage signal Vg2 to be equal to a resonance frequency fr of the resonance voltage when the dimming control signal Vdim is turned on. On the other hand, the control unit 70 provides the two control voltage signals Vg1, Vg2 with frequency to be larger than the resonance frequency fr, thus controlling the power switches Qs1,Qs2 to provide a dimming operation for the light-emitting diodes 50 when the dimming control signal Vdim is turned off. In particular, the resonance frequency fr is determined through the resonance capacitance Cr and the resonance inductances Lr,Lm. The control unit 70 receives the current frequency signal fs. If the current frequency signal fs is larger than a threshold frequency, the control unit 70 stops controlling the power switches Qs1,Qs2, thus interrupting the power supplied to the light-emitting diodes 50. In particular, the threshold frequency is determined through parameters of the transformer 30, that is, the threshold frequency is related to the leakage inductance Lr and the magnetizing inductance Lm of the transformer 30.

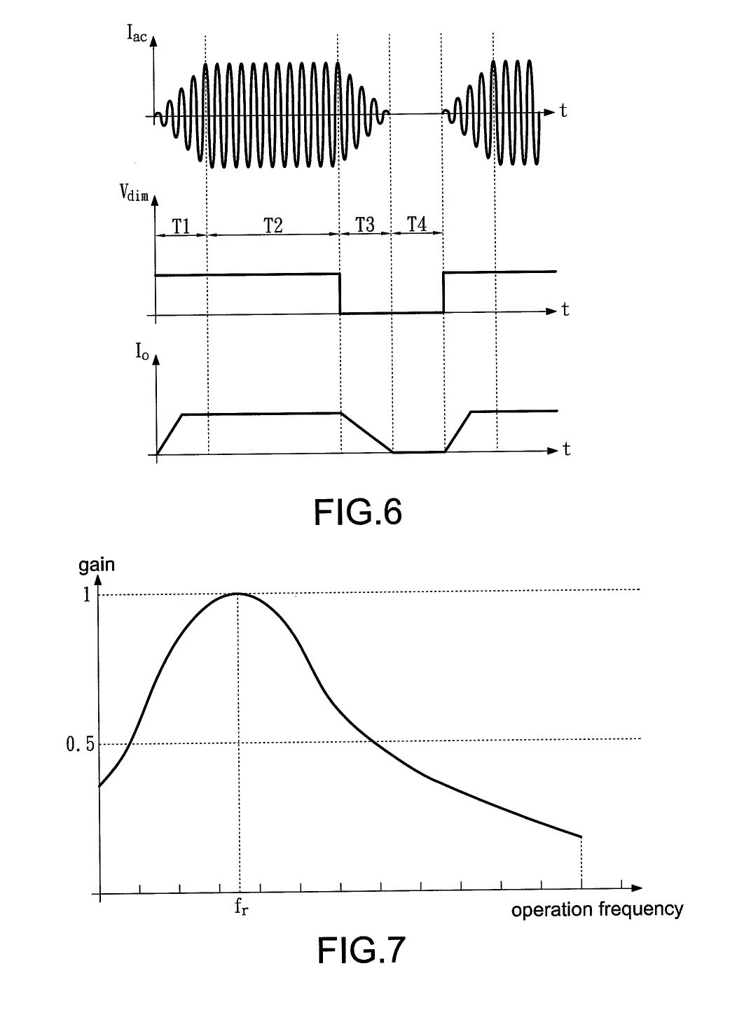

The detailed operation of the frequency-variable dimming control apparatus for the light-emitting diodes is described in the following embodiments, but not limited. Reference is made to FIG. 6 which is a schematic voltage and current waveform graph of the frequency-variable dimming control apparatus for light-emitting diodes. The graph of FIG. 6 shows, starting from the top, the secondary-side current Iac, the dimming control signal Vdim, and a driven current Io of driving the light-emitting diodes 50.

As mentioned above, the light-emitting diodes 50 are started on a first time interval T1 when the dimming control signal Vdim is high-level turned on. Afterward, the control unit 70 provides the control voltage signals Vg1,Vg2, and frequencies of the control voltage signals Vg1,Vg2 to be equal to a resonance frequency fr of the resonance voltage. At this time, the secondary-side current Iac gradually increases so that the driven current Io flowing through the light-emitting diodes 50 also increases, thus brightness of the light-emitting diodes 50 is greater. On a second time interval T2, the light-emitting diodes 50 normally operate as the driven current Io is stable. At this time, the frequency of the secondary-side current Iac is fixed and the light-emitting diodes 50 are operated at about 60 kHz in this embodiment, but not limited. Reference is made to FIG. 7 which is a DC characteristic curve graph of a resonance circuit of the frequency-variable dimming control apparatus for light-emitting diodes. When the light-emitting diodes 50 are operated in (or near) the resonance frequency fr, such as 60 kHz, a maximum voltage gain of the resonance circuit 20 can be provided to the light-emitting diodes 50.

The control unit 70 provides the control voltage signals Vg1,Vg2 to control the power switches Qs1,Qs2, and frequencies of the control voltage signals Vg1,Vg2 to be larger than the resonance frequency fr of the resonance voltage on a third time interval T3 when the dimming control signal Vdim is low-level turned off. According to the DC characteristic of the resonance circuit 20, the secondary-side current Iac would gradually decrease when frequencies of the control voltage signals Vg1,Vg2 gradually increases from the resonance frequency fr. In this embodiment, the increasing range of the frequency is from 60 kHz to 150 kHz. Hence, the driven current Io flowing through light-emitting diodes 50 would gradually decrease to provide the dimming operation for the light-emitting diodes 50. Accordingly, frequencies of the control voltage signals Vg1,Vg2 can be adjusted by the control unit 70 between the resonance frequency fr and the higher one, thus achieving the dimming operation for the light-emitting diodes 50.

In general, a voltage gain of the resonance circuit 20 is extremely small when frequencies of the control voltage signals Vg1,Vg2 exceeds 200 kHz. A fourth time interval T4 starts when the current frequency signal fs is larger than a threshold frequency, such as 150 kHz but not limited. The control unit 70 stops controlling the power switches Qs1,Qs2 to interrupt the power supplied to the light-emitting diodes 50. At this time, the secondary-side current Iac and the driven current Io are reduced to zero. In particular, the threshold frequency is determined through parameters of the transformer 30, that is, the threshold frequency is related to the leakage inductance Lr and the magnetizing inductance Lm of the transformer 30.

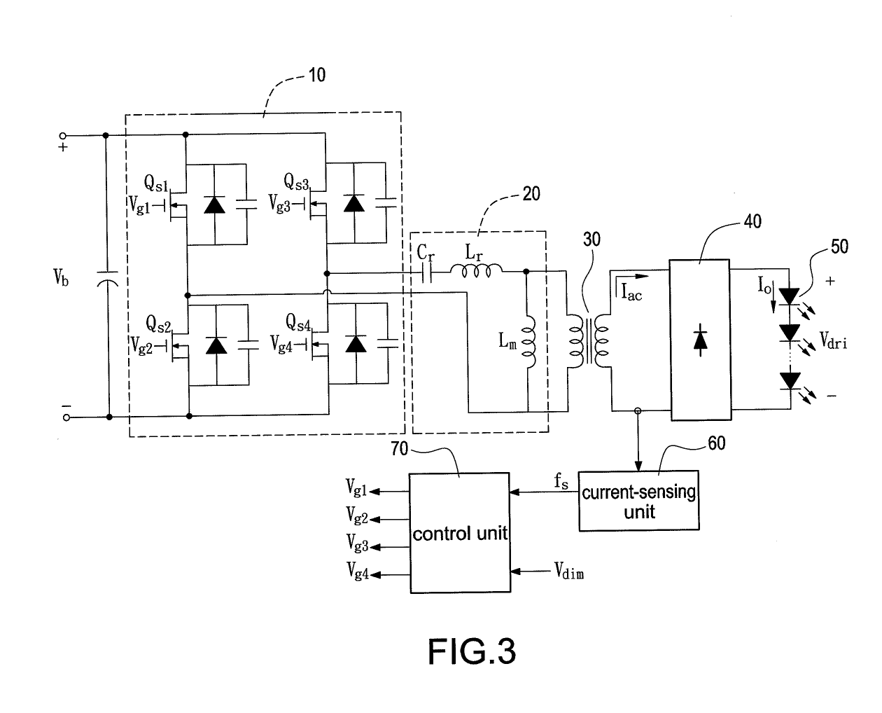

Reference is made to FIG. 3 which is a circuit diagram of the frequency-variable dimming control apparatus for light-emitting diodes according to a second embodiment of the present invention. The frequency-variable dimming control apparatus is applied to provide a dimming operation for a plurality of light-emitting diodes 50. The frequency-variable dimming control apparatus includes a DC/AC converter 10, a resonance circuit 20, a transformer 30, a rectifying circuit 40, a current-sensing unit 60, and a control unit 70. The major difference between the embodiment and the first embodiment is that the DC/AC converter 10 is a full-bridge DC/AC converter. Hence, the full-bridge DC/AC converter 10 has four power switches, namely, a first power switch Qs1, a second power switch Qs2, a third power switch Qs3, and a fourth power switch Qs4. Similarly, the DC/AC converter 10 receives a DC input voltage Vb and converts the DC input voltage Vb into an AC voltage. The resonance circuit 20 is electrically connected to the DC/AC converter 10 for receiving the AC voltage and converting the AC voltage into a resonance voltage. The transformer 30 has a primary-side winding and a secondary-side winding. The primary-side winding is electrically connected to the resonance circuit 20 for receiving the resonance voltage and outputting an AC driven voltage. The rectifying circuit 40 is electrically connected to the secondary-side winding of the transformer 30 for rectifying the AC driven voltage into a DC driven voltage Vdri, thus driving the light-emitting diodes 50. The current-sensing unit 60 is electrically connected to the secondary-side winding of the transformer 30 for sensing a secondary-side current Iac of the transformer 30 and outputting a current frequency signal fs. The control unit 70 is electrically connected between the current-sensing unit 60 and the DC/AC converter 10.

The control unit 70 receives an external dimming control signal Vdim. In particular, the external dimming control signal Vdim is provided through a microcontroller (not shown) or a pulse width modulation signal generator (not shown). The control unit 70 provides four control voltage signals, namely, a first control voltage signal Vg1, a second control voltage signal Vg2, a third control voltage signal Vg3, and a fourth control voltage signal Vg4, and frequencies of the first control voltage signal Vg1 to the fourth control voltage signal Vg4 to be equal to a resonance frequency fr of the resonance voltage when the dimming control signal Vdim is turned on. On the other hand, the control unit 70 provides the first control voltage signal Vg1 to the fourth control voltage signal Vg4 with frequency to be larger than the resonance frequency fr, thus controlling the first power switch Qs1 to the fourth power switch Qs4 to provide a dimming operation for the light-emitting diodes 50 when the dimming control signal Vdim is turned off. In particular, the resonance frequency fr is determined through the resonance capacitance Cr and the resonance inductances Lr,Lm. The control unit 70 receives the current frequency signal fs. If the current frequency signal fs is larger than a threshold frequency, the control unit 70 stops controlling the power switches Qs1,Qs2,Qs3,Qs4 to interrupt the power supplied to the light-emitting diodes 50. In particular, the threshold frequency is determined through parameters of the transformer 30, that is, the threshold frequency is related to the leakage inductance Lr and the magnetizing inductance Lm of the transformer 30. The detailed operation of the frequency-variable dimming control apparatus in this embodiment can be understood by referencing the above-mentioned description in the first embodiment.

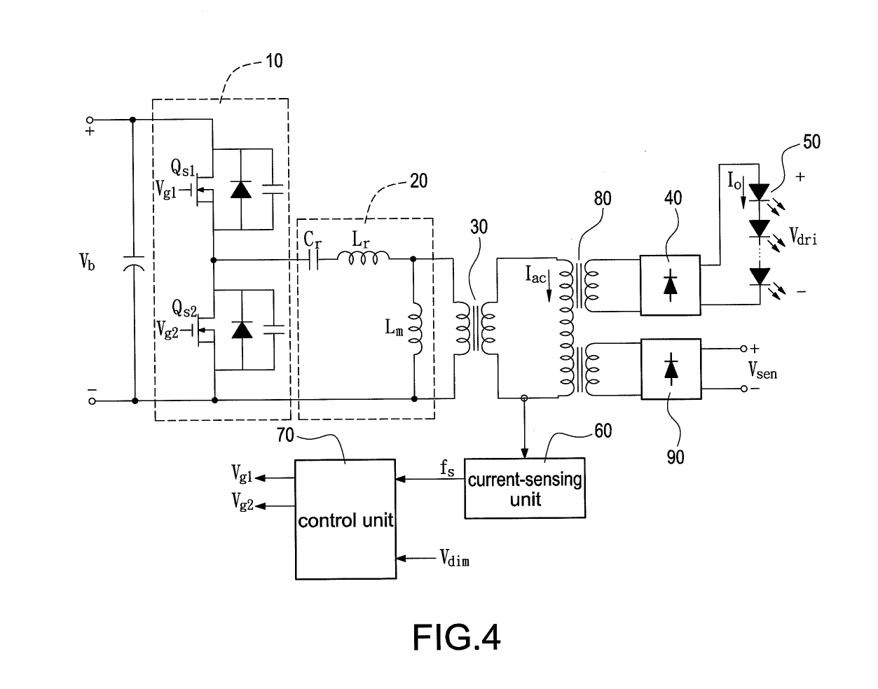

Reference is made to FIG. 4 which is a circuit diagram of the frequency-variable dimming control apparatus for light-emitting diodes according to a third embodiment of the present invention. The frequency-variable dimming control apparatus is applied to provide a dimming operation for a plurality of light-emitting diodes 50. The frequency-variable dimming control apparatus includes a DC/AC converter 10, a resonance circuit 20, a transformer 30, a rectifying circuit 40, a current-sensing unit 60, and a control unit 70. Furthermore, a three-winding transformer 80 and a second rectifying circuit 90 are provided. In particular, the three-winding transformer 80 has a first winding (not labeled), a second winding (not labeled), and a third winding (not labeled).

The major difference between the embodiment and the first embodiment is that the three-winding transformer 80 and the second rectifying circuit 90 are added. The DC/AC converter 10 receives a DC input voltage Vb and converts the DC input voltage Vb into an AC voltage. The resonance circuit 20 is electrically connected to the DC/AC converter 10 for receiving the AC voltage and converting the AC voltage into a resonance voltage. The transformer 30 has a primary-side winding and a secondary-side winding. The primary-side winding is electrically connected to the resonance circuit 20 for receiving the resonance voltage and outputting an AC driven voltage. The three-winding transformer 80 is electrically connected to the secondary-side winding to sense a driven voltage Vdri of driving the light-emitting diodes 50. The rectifying circuit 40 is electrically connected between the second winding of the three-winding transformer 80 and the light-emitting diodes 50; and the second rectifying circuit 90 is electrically connected to the third winding of the three-winding transformer 80. Accordingly, a smaller magnitude of a sensed voltage Vsen outputted from the second rectifying circuit 90 can be sensed to acquiring a greater magnitude of the driven voltage Vdri according to a turn ratio between the second winding and the third winding, thus judging whether the driven voltage Vdri of driving the light-emitting diodes 50 is abnormal or not.

The current-sensing unit 60 is electrically connected to the secondary-side winding of the transformer 30 for sensing a secondary-side current Iac of the transformer 30 and outputting a current frequency signal fs. The control unit 70 is electrically connected between the current-sensing unit 60 and the DC/AC converter 10.

The control unit 70 receives an external dimming control signal Vdim. In particular, the external dimming control signal Vdim is provided through a microcontroller (not shown) or a pulse width modulation signal generator (not shown). The control unit 70 provides two control voltage signals, namely, a first control voltage signal Vg1 and a second control voltage signal Vg2, and frequencies of the first control voltage signal Vg1 and the second control voltage signal Vg2 to be equal to a resonance frequency fr of the resonance voltage when the dimming control signal Vdim is turned on. On the other hand, the control unit 70 provides the two control voltage signals Vg1,Vg2 with frequency to be larger than the resonance frequency fr, thus controlling the power switches Qs1,Qs2 to provide a dimming operation for the light-emitting diodes 50 when the dimming control signal Vdim is turned off. In particular, the resonance frequency fr is determined through the resonance capacitance Cr and the resonance inductances Lr,Lm. The control unit 70 receives the current frequency signal fs. If the current frequency signal fs is larger than a threshold frequency, the control unit 70 stops controlling the power switches Qs1,Qs2, thus interrupting the power supplied to the light-emitting diodes 50. In particular, the threshold frequency is determined through parameters of the transformer 30, that is, the threshold frequency is related to the leakage inductance Lr and the magnetizing inductance Lm of the transformer 30. The detailed operation of the frequency-variable dimming control apparatus in this embodiment can be understood by referencing the above-mentioned description in the first embodiment.

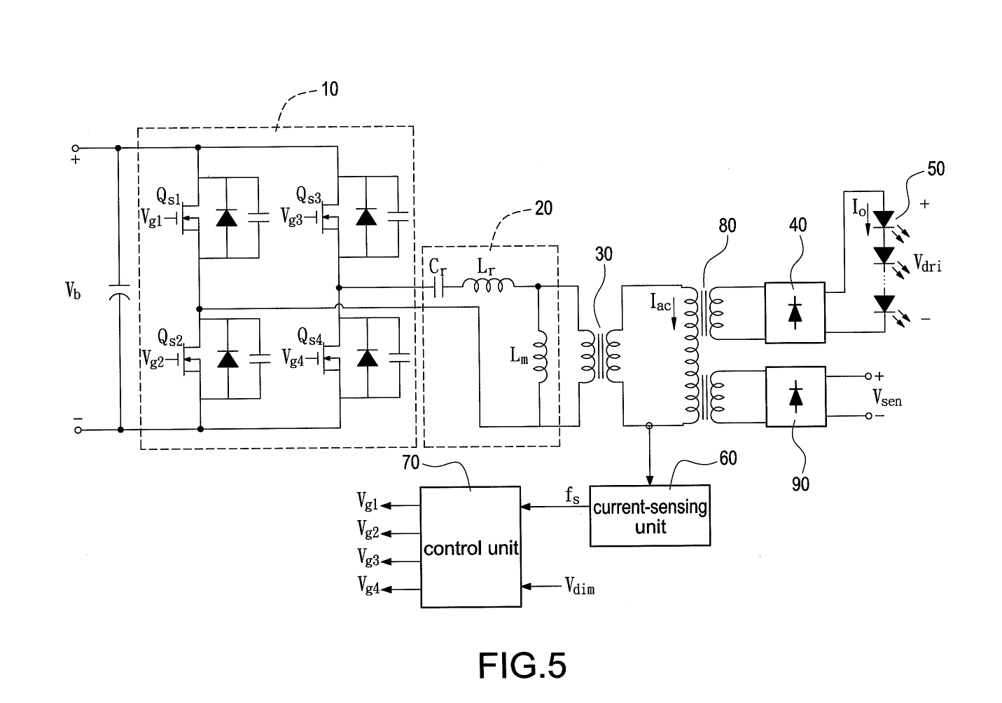

Reference is made to FIG. 5 which is a circuit diagram of the frequency-variable dimming control apparatus for light-emitting diodes according to a fourth embodiment of the present invention. The frequency-variable dimming control apparatus is applied to provide a dimming operation for a plurality of light-emitting diodes 50. The frequency-variable dimming control apparatus includes a DC/AC converter 10, a resonance circuit 20, a transformer 30, a rectifying circuit 40, a current-sensing unit 60, and a control unit 70. Furthermore, a three-winding transformer 80 and a second rectifying circuit 90 are provided. In particular, the three-winding transformer 80 has a first winding, a second winding, and a third winding.

The major difference between the embodiment and the second embodiment is that the three-winding transformer 80 and the second rectifying circuit 90 are added. The DC/AC converter 10 receives a DC input voltage Vb and converts the DC input voltage Vb into an AC voltage. The resonance circuit 20 is electrically connected to the DC/AC converter 10 for receiving the AC voltage and converting the AC voltage into a resonance voltage. The transformer 30 has a primary-side winding and a secondary-side winding. The primary-side winding is electrically connected to the resonance circuit 20 for receiving the resonance voltage and outputting an AC driven voltage. The three-winding transformer 80 is electrically connected to the secondary-side winding to sense a driven voltage Vdri of driving the light-emitting diodes 50. The rectifying circuit 40 is electrically connected between the second winding of the three-winding transformer 80 and the light-emitting diodes 50; and the second rectifying circuit 90 is electrically connected to the third winding of the three-winding transformer 80. Accordingly, a smaller magnitude of a sensed voltage Vsen outputted from the second rectifying circuit 90 can be sensed to acquiring a greater magnitude of the driven voltage Vdri according to a turn ratio between the second winding and the third winding, thus judging whether the driven voltage Vdri of driving the light-emitting diodes 50 is abnormal or not.

The current-sensing unit 60 is electrically connected to the secondary-side winding of the transformer 30 for sensing a secondary-side current Iac of the transformer 30 and outputting a current frequency signal fs. The control unit 70 is electrically connected between the current-sensing unit 60 and the DC/AC converter 10.

The control unit 70 receives an external dimming control signal Vdim. In particular, the external dimming control signal Vdim is provided through a microcontroller (not shown) or a pulse width modulation signal generator (not shown). The control unit 70 provides four control voltage signals, namely, a first control voltage signal Vg1, a second control voltage signal Vg2, a third control voltage signal Vg3, and a fourth control voltage signal Vg4, and frequencies of the first control voltage signal Vg1 to the fourth control voltage signal Vg4 to be equal to a resonance frequency fr of the resonance voltage when the dimming control signal Vdim is turned on. On the other hand, the control unit 70 provides the first control voltage signal Vg1 to the fourth control voltage signal Vg4 with frequency to be larger than the resonance frequency fr, thus controlling the first power switch Qs1 to the fourth power switch Qs4 to provide a dimming operation for the light-emitting diodes 50 when the dimming control signal Vdim is turned off. In particular, the resonance frequency fr is determined through the resonance capacitance Cr and the resonance inductances Lr,Lm. The control unit 70 receives the current frequency signal fs. If the current frequency signal fs is larger than a threshold frequency, the control unit 70 stops controlling the power switches Qs1,Qs2,Qs3,Qs4 to interrupt the power supplied to the light-emitting diodes 50. In particular, the threshold frequency is determined through parameters of the transformer 30, that is, the threshold frequency is related to the leakage inductance Lr and the magnetizing inductance Lm of the transformer 30. The detailed operation of the frequency-variable dimming control apparatus in this embodiment can be understood by referencing the above-mentioned description in the first embodiment.

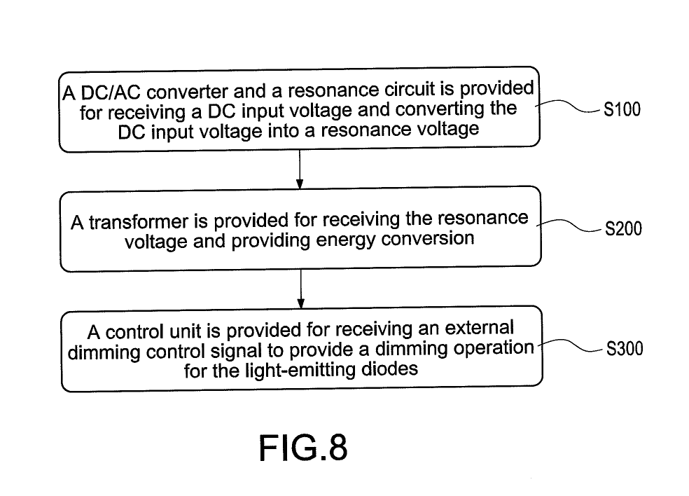

Reference is made to FIG. 8 which is a flowchart of a method for operating the frequency-variable dimming control apparatus for light-emitting diodes of the present invention. The method for operating a frequency-variable dimming control apparatus to provide a dimming operation for a plurality of light-emitting diodes; steps of operating the frequency-variable dimming control apparatus includes: First, a DC/AC converter and a resonance circuit is provided for receiving a DC input voltage and converting the DC input voltage into a resonance voltage (S100). In the present invention, the DC/AC converter can be a half-bridge DC/AC converter, a full-bridge DC/AC converter, or a class-E converter, but not limited. The DC/AC converter has a plurality of power switches for receiving the DC input voltage and converting the DC input voltage into an AC voltage. The resonance circuit is electrically connected to the DC/AC converter for receiving the AC voltage and converting the AC voltage into the resonance voltage.

Afterward, a transformer is provided for receiving the resonance voltage and providing energy conversion (S200). The transformer 30 has a primary-side winding and a secondary-side winding. The primary-side winding is electrically connected to the resonance circuit for receiving the resonance voltage and outputting an AC driven voltage. In particular, the resonance circuit includes a resonance capacitance and two resonance inductances (including a leakage inductance and a magnetizing inductance of the transformer), which form a LLC resonance circuit.

Finally, a control unit is provided for receiving an external dimming control signal to provide a dimming operation for the light-emitting diodes (S300). The control unit is electrically connected to the DC/AC converter to receive the external dimming control signal. The control unit provides a plurality of control voltage signals, and frequencies of the control voltage signals to be equal to a resonance frequency of the resonance voltage when the dimming control signal is turned on. On the other hand, the control unit provides a plurality of control voltage signals, and frequencies of the control voltage signals to be larger than the resonance frequency when the dimming control signal is turned off, thus providing a dimming operation for the light-emitting diodes. In particular, the resonance frequency is determined through the resonance capacitance and the resonance inductances. In addition, the external dimming control signal is provided through a microcontroller or a pulse width modulation signal generator.

Furthermore, the method for operating the frequency-variable dimming control apparatus further provides a current-sensing unit for sensing a secondary-side current of the transformer and outputting a current frequency signal. The control unit receives the current frequency signal. If the current frequency signal is larger than a threshold frequency, the control unit stops controlling the DC/AC converter, thus interrupting the power supplied to the light-emitting diodes. In particular, the threshold frequency is determined through parameters of the transformer, that is, the threshold frequency is related to the leakage inductance and the magnetizing inductance of the transformer. In addition, the method for operating the frequency-variable dimming control apparatus further provides a rectifying circuit for rectifying an AC driven voltage outputted from the transformer into a DC driven voltage, thus driving the light-emitting diodes.

In conclusion, the present invention has following advantages:

1. According to on/off states of the dimming control signal, the control unit provides frequency-variable control voltage signals to execute a dimming operation for the light-emitting diodes. Hence, this is to effectively reduce the amount of transistor switches, costs, and increase reliability of dimming the light-emitting diodes 50; and

2. The smaller magnitude of the sensed voltage Vsen can be directly and simply sensed to acquire the greater magnitude of the DC driven voltage Vdri according to a turn ratio between the windings of the three-winding transformer 80. Hence, DC driven voltage Vdri of the light-emitting diodes 50 can be conveniently and reliably sensed.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A frequency-variable dimming control apparatus is applied to provide a dimming operation for a plurality of light-emitting diodes; the frequency-variable dimming control apparatus comprising:
a DC/AC converter having a plurality of power switches, and the DC/AC converter receiving a DC input voltage and converting the DC input voltage into an AC voltage;
a resonance circuit electrically connected to the DC/AC converter, and the resonance circuit receiving the AC voltage and converting the AC voltage into a resonance voltage;
a transformer having a primary-side winding and the primary-side winding electrically connected to the resonance circuit to receive the resonance voltage; and
a control unit electrically connected to the DC/AC converter, and the control unit receiving an external dimming control signal;
wherein the control unit provides a plurality of control voltage signals; wherein frequencies of the control voltage signals to be equal to a resonance frequency of the resonance voltage when the dimming control signal is turned on; wherein frequencies of the control voltage signals to be larger than the resonance frequency of the resonance voltage when the dimming control signal is turned off.

2. The frequency-variable dimming control apparatus of claim 1, further comprising:
a current-sensing unit electrically connected between the control unit and a secondary-side winding of the transformer for sensing a secondary-side current of the transformer.

3. The frequency-variable dimming control apparatus of claim 2, wherein the current-sensing unit further outputs a current frequency signal which is received by the control unit, the control unit stops controlling the power switches of the DC/AC converter, thus interrupting the power supplied to the light-emitting diodes if the current frequency signal is larger than a threshold frequency.

4. The frequency-variable dimming control apparatus of claim 1, further comprising:
a rectifying circuit electrically connected to a secondary-side winding of the transformer for rectifying an AC driven voltage outputted from the transformer into a DC driven voltage, thus driving the light-emitting diodes.

5. The frequency-variable dimming control apparatus of claim 1, wherein the resonance circuit comprises a resonance capacitance and two resonance inductances, the resonance frequency is determined through the resonance capacitance and the resonance inductances.

6. The frequency-variable dimming control apparatus of claim 3, wherein the threshold frequency is determined through parameters of the transformer.

7. The frequency-variable dimming control apparatus of claim 1, wherein the DC/AC converter is a half-bridge DC/AC converter.

8. The frequency-variable dimming control apparatus of claim 1, wherein the DC/AC converter is a full-bridge DC/AC converter.

9. The frequency-variable dimming control apparatus of claim 1, wherein the DC/AC converter is a class-E converter.

10. The frequency-variable dimming control apparatus of claim 1, wherein the external dimming control signal is a pulse width modulation signal, and the external dimming control signal is provided through a microcontroller or a pulse width modulation signal generator.

11. A method for operating a frequency-variable dimming control apparatus for a plurality of light-emitting diodes; steps of operating the frequency-variable dimming control apparatus comprising:
(a) providing a DC/AC converter and a resonance circuit for receiving a DC input voltage and converting the DC input voltage into a resonance voltage;
(b) providing a transformer for receiving the resonance voltage; and
(c) providing a control unit for receiving an external dimming control signal;
wherein, the control unit provides a plurality of control voltage signals to render frequencies of the control voltage signals to be equal to a resonance frequency of the resonance voltage when the dimming control signal is turned on; the control unit provides the control voltage signals to render frequencies of the control voltage signals to be larger than the resonance frequency of the resonance voltage when the dimming control signal is turned off.

12. The method for operating the frequency-variable dimming control apparatus of claim 11, further comprising:
(d) providing a current-sensing unit for sensing a secondary-side current of the transformer and outputting a current frequency signal.

13. The method for operating the frequency-variable dimming control apparatus of claim 12, in the step (d), the control unit receives the current frequency signal and the control unit stops controlling the DC/AC converter, thus interrupting power supplied to the light-emitting diodes if the current frequency signal is larger than a threshold frequency.

14. The method for operating the frequency-variable dimming control apparatus of claim 11, further comprising:
(e) providing a rectifying circuit for rectifying an AC driven voltage outputted from the transformer into a DC driven voltage, thus driving the light-emitting diodes.

15. The method for operating the frequency-variable dimming control apparatus of claim 11, wherein the resonance circuit comprises a resonance capacitance and two resonance inductances, and the resonance frequency is determined through the resonance capacitance and the resonance inductances.

16. The method for operating the frequency-variable dimming control apparatus of claim 13, wherein the threshold frequency is determined through parameters of the transformer.

17. The method for operating the frequency-variable dimming control apparatus of claim 11, wherein the DC/AC converter is a half-bridge DC/AC converter.

18. The method for operating the frequency-variable dimming control apparatus of claim 11, wherein the DC/AC converter is a full-bridge DC/AC converter.

19. The method for operating the frequency-variable dimming control apparatus of claim 11, wherein the DC/AC converter is a class-E converter.

20. The method for operating the frequency-variable dimming control apparatus of claim 11, wherein the external dimming control signal is a pulse width modulation signal, and the external dimming control signal is provided through a microcontroller or a pulse width modulation signal generator.
